(19) United States
(12) Patent Application Publication
(10) Pub. No.: US 2022/0021463 A1
(43) Pub. Date: Jan. 20, 2022

(54) DEVICE AND METHOD FOR REAL-TIME CALIBRATION AND COMPENSATION FOR TRANSMITTER POWER IMBALANCE IN A COHERENT TRANSCEIVER

(71) Applicants: Xuefeng TANG, Kanata (CA); Wing Chau NG, Kanata (CA); Zhiping JIANG, Kanata (CA); Zhuhong ZHANG, Ottawa (CA)

(72) Inventors: Xuefeng TANG, Kanata (CA); Wing Chau NG, Kanata (CA); Zhiping JIANG, Kanata (CA); Zhuhong ZHANG, Ottawa (CA)

(21) Appl. No.: 16/929,962

(22) Filed: Jul. 15, 2020

(51) Int. Cl. H04B 10/564; H04B 10/548; G02F 1/21

(52) U.S. Cl. CPC H04B 10/564; G02F 2001/212; G02F 1/21; H04B 10/548

(57) ABSTRACT

Methods and devices for power imbalance compensation and calibration of a coherent transmitter or transceiver are described. A pilot tone is combined with a digital data signal such that relative amplitudes of the pilot tone in each of four transmitted optical data channels may be detected by a pilot tone detector and used to calculate any power imbalances between I/Q phase channels and/or X/Y polarized channels of the transmitter. The pilot tone detector applies gain to the data signal of the transmitter to compensate for any calculated power imbalances. Because the pilot tone is combined with the digital data signal, its amplitude in each received channel is proportional to the data signal power of that channel.

### RELATED APPLICATIONS

This is the first patent application related to this matter.

### FIELD

The present disclosure is related to methods and devices for optical transmission, and in particular to methods and devices for compensating for coherent transmitter power imbalances.

### BACKGROUND

Coherent optical transmitters (also called coherent transmitters) are used to generate and transmit optical signals by modulating the amplitude and phase, of light transmitted through an optical channel, such as a fiber optic cable. For example, amplitude and phase modulation may be carried out as quadrature amplitude modulation (QAM) on each of two polarizations (X, Y) of an optical carrier to achieve polarization multiplexing. One technique for coherent transmission involves using four separate electrical data channels to modulate four modulation components of the optical signal: an in-phase modulation component (I) and a quadrature modulation component (Q) for a horizontal X-direction polarization (X), and a vertical Y-direction polarization respectively. The four channels are: an XI channel encoding in-phase modulation of the X-direction polarization; an XQ channel encoding quadrature modulation of the X-direction polarization; a YI channel encoding in-phase modulation of the Y-direction polarization and a YQ channel encoding quadrature modulation of the Y-direction polarization.

For high-speed coherent optical transmissions, power imbalances among the data channels used to generate such a polarization-multiplexed in-phase and quadrature modulated signal is one of the major transmitter impairments that degrades transmission performance, especially for high-order modulation formats (e.g. 64QAM) at high baud rates. It may cause severe performance degradation and transmission failure.

An IQ power imbalance (i.e. between XI and XQ, or between YI and YQ) may cause constellation distortion and signal to noise ratio (SNR) differences in I and Q modulation components, which is referred to as IQ power imbalance or IQ gain imbalance. Moreover, a power imbalance between the X and Y polarizations at the output of the transmitter may cause polarization-dependent loss (PDL), which may cause optical SNR (OSNR) difference along X and Y polarizations. These power imbalances could be caused by various factors, such as an imperfect power ratio in optical coupling and splitting, gain fluctuation in modulator drivers due to temperature changes, dependence of modulation efficiency on carrier wavelength and component aging effects, etc.

These power imbalances may be compensated for using a one-time factory calibration procedure. However, the compensation performance of the factory calibration may be degraded in the field due to operating environment changes. Moreover, factory calibration based on a selected single wavelength (i.e. an optical carrier at a particular frequency) may not be applicable to other wavelengths (i.e. at another frequencies), and this may cause a performance penalty when switching wavelengths in operation.

These power imbalances may shape the constellation of the received optical signal and cause decision errors based on the data information. It may be compensated dynamically to some extent by performing IQ equalization at the receiver (Rx) digital signal processor (DSP) at the expense of increasing the implementation complexity of the receiver application-specific integrated circuit (ASIC) and its power consumption. One such technique is described by C.R.S. Fludger and T. Kupfer in “Transmitter Impairment Mitigation and Monitoring for High Baud-Rate, High Order Modulation Systems”, ECOC 2016. However, in the presence of optical noise, the difference in SNRs between the I and Q modulation components cannot be compensated for on the receiver side of an optical communication link.

IQ imbalance can also be calibrated using deconstructive interference between the I and Q data channels, as described Y. Yue, Q. Wang, B. Zhang, A. Vovan, and J. Anderson in “Detection and compensation of power imbalances for DP-QAM transmitter using reconfigurable interference,” Proc. SPIE 10130, 101300M (2017). However, this approach only works for factory calibration or calibration of a device during its power-up phase, because it requires a specific pattern to be loaded to the I and Q channels.

Optical power measurement methods have been used to perform in-traffic monitoring, as described by Qiang Wang, Yang Yue, and Jon Anderson in “Detection and compensation of power imbalance, modulation strength, and bias drift in coherent IQ transmitter through digital filter”, Optics Express, 2018. However, these methods require a sophisticated pre-calibration process to populate a parameter look-up table to address the wavelength dependency or by dithering the transmitter finite impulse response (FIR) filter gain to introduce a measureable change in the optical power. The accuracy of FIR dithering methods depends on the bias-point of the modulator.

In a technique described by M. Sotoodeh, Y. Beaulieu, J. Harley, and D. McGhan in “Modulator Bias and Optical Power Control of Optical Complex E-Field Modulators,” J. Lightwave Technol. 29(15), 2235-2248 (2011), a dithering signal is applied to the DC bias of the I and Q MZMs and the power of I and Q can be detected from the second harmonic of the dither signal. This method needs a complicated calibration process to extract the modulation slop and Vπ for each MZ modulator. Second harmonic detection may require a relatively strong dither signal applied to DC bias voltages to achieve a good measurement sensitivity and accuracy, which may cause a penalty to the transmission performance if performing real-time monitoring. To deal with the wavelength dependency and component aging effect, a power-up pre-calibration is required, which is not a preferred operation due to requiring an interruption of the service.

Thus, there is a need for a coherent transmitter power imbalance calibration or compensation technique which overcomes one or more of the above-noted disadvantages of existing techniques.

### SUMMARY

In various embodiments described herein, methods and devices are disclosed that provide real-time monitoring and compensation of coherent transmitter I/Q and/or X/Y power imbalances at the transmitter side to compensate for SNR difference between I and Q modulation components and/or X and Y polarization components. Various embodiments may enable an optical transmitter to combine one or more pilot tones with the digital data channels used to modulate the optical signal. The optical signal output of the transmitter is monitored by a pilot tone detector component of the transmitter, which detects the amplitude of each pilot tone and calculates amplitude ratios between the detected pilot tones of each modulation component. These amplitude ratios are indicative of power imbalances between their respective data channels. The transmitter uses a gain control unit to apply digital gain to the digital data channels and/or analog gain to the analog data channels used to drive the optical modulator, thereby compensating for any detected I/Q and/or X/Y power imbalances. In some embodiments, this pilot tone generation, detection, and compensation technique may be applied in real-time, i.e. during a service mode of the transmitter while it is actively transmitting an optical data signal across a communication link.

A “modulation component” of a signal refers to a characteristic of a signal that may be modulated to encode data, e.g., amplitude, frequency, phase, or polarity. As used herein, however, unless otherwise specified, the term “modulation component” refers specifically to either an in-phase (I) component or a quadrature (Q) component of a quadrature amplitude modulated (QAM) signal. In the case of a polarization-multiplexed signal (i.e. a first QAM signal at a first polarization direction and a second QAM signal at a second, typically orthogonal, polarization direction), a modulation component may refer to the I or Q component of one of the QAM signals.

As any of the above-noted modulation components of an optical signal may encode data from a data channel at the transmitter and may be decoded to yield a data channel at a receiver, a modulation component may occasionally be referred to herein as a “channel” or “modulation channel” of the optical signal. As a QAM signal consists of two, phase orthogonal, modulation data channels (corresponding to the I and Q modulation components), a polarization-multiplexing quadrature-phase modulator generates a signal having four modulation channels: a first modulation component in a first polarization direction (e.g. an I modulation component in a horizontal X polarization direction), a second modulation component in the first polarization direction (e.g. a Q modulation component in the X polarization direction), a first modulation component in a second polarization direction (e.g. an I modulation component in a vertical Y polarization direction), and a second modulation component in a second polarization direction (e.g. a Q modulation component in the vertical Y polarization direction). Each of these channels may encode data independently of the other three channels.

Modulation components and/or polarization directions may occasionally be referred to herein by a shortened form thereof. For example, X-direction polarization may be referred to herein as “X polarization”, or sometimes simply “X”. Similarly, an in-phase (real) phase modulation component may be referred to herein as an “in-phase modulation component”, an “in-phase component”, an “I modulation component”, an “I component”, or sometimes simply “I”. It will be appreciated that the capital letters X, Y, Q, and I as used herein refer to the respective components of a signal, the corresponding data channels used to modulate said signal components, or the corresponding data channels decoded or demodulated from said signal components. Similarly, any combination of two such letters (XI, YI, XQ, YQ, IQ, XY, or reversed versions thereof) indicates a modulation component in a polarization direction or a data channel modulating, or demodulated from, such a signal component.

In some aspects, the present disclosure describes a device. The device has a pilot tone generator configured to combine a pilot tone with a digital data signal, thereby generating a modified digital data signal. The device has an electro-optic modulator (EOM) configured to generate an optical signal based on the modified digital data signal. The optical signal includes at least one in-phase modulation component and at least one quadrature modulation component. The device has a gain control unit. The device has a pilot tone detector. The pilot tone detector is configured to receive the optical signal, generate a pilot tone detector digital signal based on the optical signal, detect pilot tone signal characteristics based on the pilot tone detector digital signal, use the pilot tone signal characteristics to determine at least one modulation component power imbalance between at least one of the in-phase modulation components and at least one of the quadrature modulation components of the optical signal, and provide feedback to the gain control unit based on the at least one modulation component power imbalance. The gain control unit is configured to apply gain based on the feedback.

In some aspects, the present disclosure describes a method. A pilot tone generator is used to combine a pilot tone with a digital data signal, thereby generating a modified digital data signal. An electro-optic modulator (EOM) is used to generate an optical signal based on the modified digital data signal. The optical signal includes at least one in-phase modulation component and at least one quadrature modulation component. A pilot tone detector is used to receive the optical signal, generate a pilot tone detector digital signal based on the optical signal, detect pilot tone signal characteristics based on the pilot tone detector digital signal, use the pilot tone signal characteristics to determine at least one modulation component power imbalance between at least one of the in-phase modulation components and at least one of the quadrature modulation components of the optical signal, and provide feedback to a gain control unit based on the at least one power imbalance. The gain control unit is used to apply gain based on the feedback.

In some examples, the at least one in-phase modulation component comprises a first in-phase modulation component at a first polarization direction and a second in-phase modulation component at a second polarization direction. The at least one quadrature modulation component comprises a first quadrature modulation component at a first polarization direction and a second quadrature modulation component at a second polarization direction. The pilot tone detector is further configured to use the pilot tone signal characteristics to determine at least one polarization direction power imbalance between at least one of the modulation components at the first polarization direction and at least one of the modulation components at the second polarization direction. The feedback is also based on the polarization direction power imbalance.

In some examples, the modified digital data signal is encoded in four orthogonal data channels: an XI channel encoding the first in-phase modulation component, a XQ channel encoding the first quadrature modulation component, an YI channel encoding the second in-phase modulation component, and a YQ channel encoding the second quadrature modulation component. The electro-optic modulator comprises a dual-polarization quad-parallel Mach-Zehnder (DP-QPMZ) modulator having four channel paths, each channel path being modulated by one of the four orthogonal data channels.

In some examples, the pilot tone is combined with the digital data signal using amplitude modulation. Detecting pilot tone signal characteristics based on the pilot tone detector digital signal comprises detecting an amplitude of the pilot tone in each of four channels of the pilot tone detector digital signal: a pilot tone detector XI channel, a pilot tone detector XQ channel, a pilot tone detector YI channel, and a pilot tone detector YQ channel.

In some examples, the pilot tone detector comprises a low-speed photodetector for receiving the optical signal and generating a pilot tone detector analog signal based on the optical signal, an analog-to-digital converter (ADC) for generating the pilot tone detector digital signal based on the pilot tone detector analog signal, and a pilot tone detector digital signal processing (DSP) unit for detecting the amplitude of the pilot tone in each of the four channels of the pilot tone detector digital signal by applying a fast Fourier transform to the pilot tone detector digital signal, and using the pilot tone signal characteristics to determine the at least one modulation component power imbalance and the at least one polarization direction power imbalance by calculating one or more amplitude ratios between the pilot tone detected in two or more of the four channels of the pilot tone detector digital signal.

In some examples, the pilot tone comprises four pilot tone channels, each pilot tone channel having a different modulation frequency from the modulation frequency of each other pilot tone channel. Each pilot tone channel is combined with one of the four orthogonal data channels to generate the modified digital data signal.

In some examples, combining the pilot tone with the digital data signal comprises, for each of four predetermined time periods, combining the pilot tone with a respective channel of the four orthogonal data channels using amplitude modulation. Detecting pilot tone signal characteristics comprises identifying the four channels of the pilot tone detector digital signal, and, for each of four sampling time periods, each sampling time period corresponding to one of the four predetermined time periods, detecting pilot tone signal characteristics of a respective channel of the pilot tone detector digital signal.

In some examples, the device further comprises a digital-to-analog converter (DAC) for converting the modified electrical digital signal into an analog data signal. The device further comprises an amplifier for amplifying the analog data signal to generate an amplified analog data signal, the amplified analog data signal driving the electro-optic modulator, the optical signal being based on the amplified analog data signal. The gain control unit applies gain adjustment based on the feedback to the amplifier to change a power level of the amplified analog data signal.

In some examples, the device further comprises a digital signal processing (DSP) unit for setting a power level of the digital data signal. The gain control unit further applies digital gain based on the feedback to the electrical digital signal using the DSP unit.

In some aspects, the present disclosure describes a device. The device comprises a pilot tone detector. The pilot tone detector comprises a low-speed photodetector for receiving an optical signal and generating a pilot tone detector analog signal based on the optical signal. The pilot tone detector comprises an analog-to-digital converter (ADC) for generating a pilot tone detector digital signal based on the pilot tone detector analog signal. The pilot tone detector comprises a pilot tone detector digital signal processor (DSP) for detecting an amplitude of a pilot tone in each of four channels of the pilot tone detector digital signal by applying a fast Fourier transform to the pilot tone detector digital signal, and using signal characteristics of the pilot tone to determine at least one power imbalance by calculating one or more amplitude ratios between the pilot tone detected in two or more of the four channels of the pilot tone detector digital signal.

In some examples, the at least one power imbalance includes a modulation component power imbalance between an in-phase modulation component and a quadrature modulation component of the optical signal.

In some examples, the at least one power imbalance includes a polarization direction power imbalance between a first polarization direction and a second polarization direction of the optical signal.

In some examples, the device further comprises a pilot tone generator configured to combine the pilot tone with a digital data signal, thereby generating a modified digital data signal. The device further comprises a digital-to-analog converter (DAC) for converting the modified electrical digital signal into an analog data signal. The device further comprises an amplifier for amplifying the analog data signal to generate an amplified analog data signal for driving an electro-optic modulator. The device further comprises an electro-optic modulator (EOM) configured to generate an optical signal based on the modified digital data signal. The device further comprises a gain control unit, wherein the pilot tone detector DSP is further configured to provide feedback to the gain control unit based on the at least one power imbalance, and the gain control unit is configured to apply digital gain based on the feedback to the digital data signal, and apply analog gain based on the feedback to the amplified analog data signal.

### BRIEF DESCRIPTION OF THE DRAWINGS

Reference will now be made, by way of example, to the accompanying drawings which show example embodiments of the present application, and in which:

FIG. 1 is a schematic of a dual-polarization quad-parallel Mach-Zehnder (DP-QPMZ) modulator, in accordance with examples described herein.

FIG. 2 is a block diagram of a coherent transmitter device with power imbalance compensation, in accordance with examples described herein.

FIG. 3 is a graph of four pilot tones in power and frequency, in accordance with a first example described herein.

FIG. 4 is a graph of a single pilot tone in power and frequency, in accordance with a second example described herein.

FIG. 5 is a schematic showing injection of the single pilot tone of FIG. 4 into four channels of a data signal at different predetermined times, in accordance with the second example of FIG. 4.

FIG. 6 is a flowchart showing an example method of power imbalance compensation in a coherent transmitter, in accordance with examples described herein.

Similar reference numerals may have been used in different figures to denote similar components.

### DESCRIPTION OF EXAMPLE EMBODIMENTS

In examples disclosed herein, methods and apparatuses are described that provide real-time monitoring and compensation of coherent transmitter power imbalances between I and Q modulation components and/or X and Y polarization components.

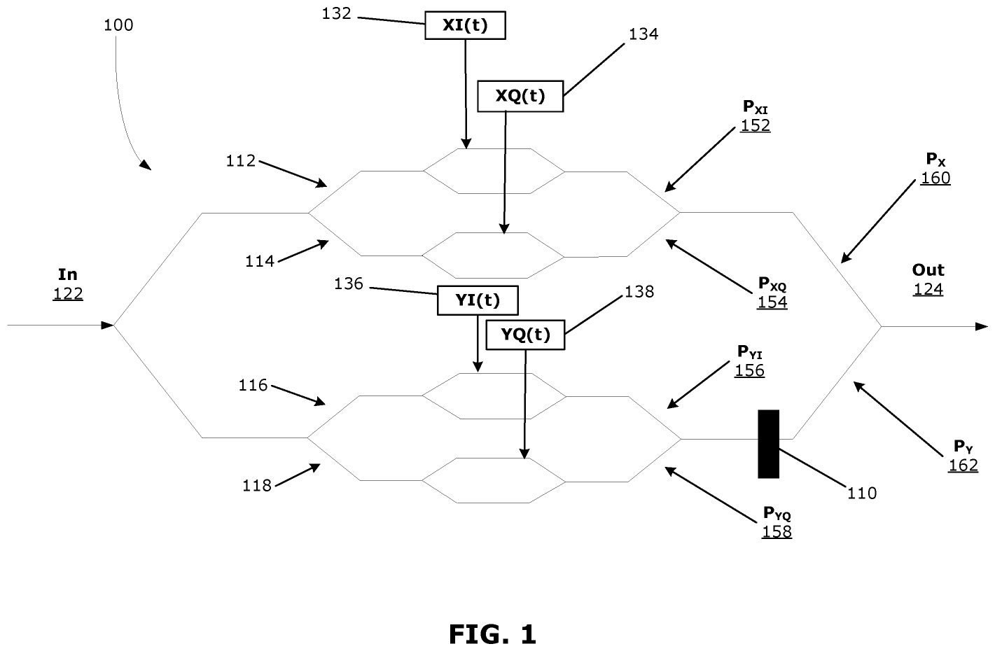

FIG. 1 is a schematic illustrating the channel paths of an electro-optical modulator (EOM) 100, shown here as a dual-polarization quad-parallel Mach-Zehnder (DP-QPMZ) modulator having four channel paths 112, 114, 116, 118, each channel path being modulated by an analog electrical data channel input 132, 134, 136, 138. A DP-QPMZ modulator is a polarization-multiplexed version of a DP-MZM (Dual-Parallel Mach-Zehnder Modulator), which in turn is a special case of a MZM (Mach-Zehnder Modulator). The present described embodiments are not limited to a DP-QPMZ modulator but may use any optical modulator suitable to carry out dual-polarization (i.e. polarization-multiplexed) I/Q modulation (i.e. QAM).

The EOM 100 receives an optical input 122 in the form of a laser providing a single-wavelength light source (i.e. an optical carrier at a particular frequency), such as a laser. The optical input 122 is split into two paths, each of which is split into a further two paths, in accordance with optical interferometry techniques. This yields four channel paths: an XI path 112, an XQ path 114, a YI path 116, and a YQ path 118. The XI path 112 receives an analog electrical signal from an XI channel 132, which modulates an I component of the signal propagated through the XI channel path 112 to form an I modulated signal with X polarization having power level P_{XI} 152. Each of the other three paths is similarly modulated by an analog electrical signal: the XQ path 114 by XQ channel 134 to form a Q modulated signal with X polarization having power level P_{XQ} 154; the YI path 116 by YI channel 136 to form an I modulated signal with Y polarization having power level P_{YI} 156, and the YQ path 118 by YQ channel 138 to form a Q modulated signal with Y polarization having power level P_{YQ} 158. The optical signal outputs of the XI path 112 and XQ path 114 are coupled or combined to form a modulated complex signal at X polarization (XI+j*XQ) (also called the “X polarized signal”) with power level P_{X} 160, and the optical signal outputs of the YI path 116 and YQ path 118 are coupled or combined and fed through a polarization rotator 110 to form a modulated complex signal at Y polarization (YI+j*YQ) (also called the “Y polarized signal”) with power level P_{Y} 162. The X polarized signal and Y polarized signal are coupled or combined to form an optical signal 124 at the output of the EOM 100.

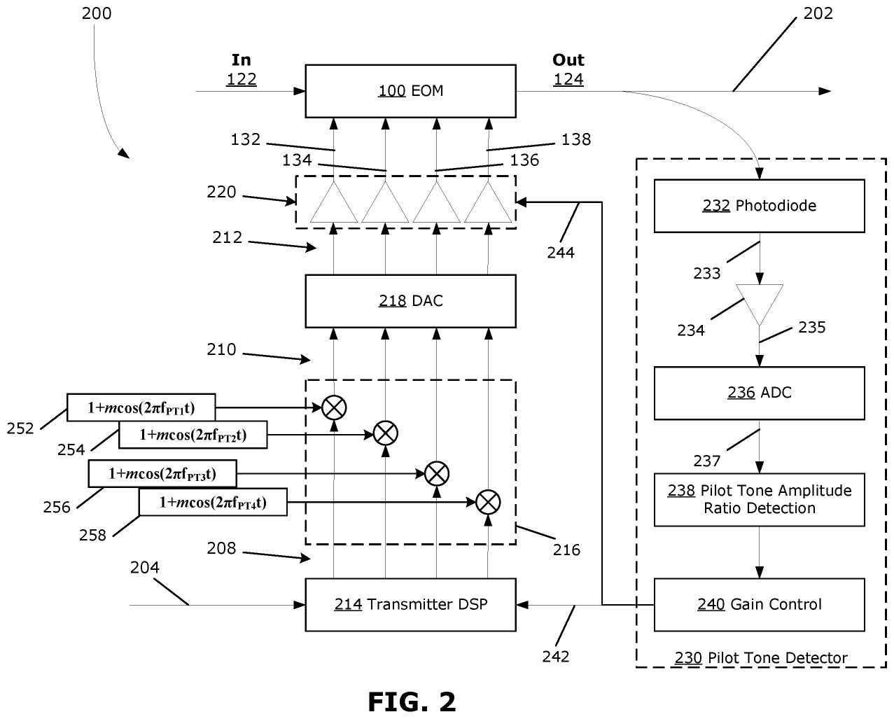

The four orthogonal data channels XI 132, XQ 134, YI 136, and YQ 138 are analog electrical data channels of an amplified analog electrical data signal used to drive the EOM 100. The amplified analog electrical data signal is described in greater detail below with reference to FIG. 2.

FIG. 2 is a block diagram of a coherent transmitter device 200 with power imbalance compensation. The device 200 uses an EOM 100, such as the DP-QPMZ modulator of FIG. 1, to modulate an optical signal 124 for transmission across an optical communication link 202. The optical signal 124 encodes one or more pilot tones generated by a pilot tone generator 216 and combined with the data channels used to drive the EOM 100. A small portion of the optical signal 124 modulated by the EOM 100 is tapped into a pilot tone detector 230, which detects amplitude ratios between the pilot tone present in each modulation component of the optical signal 124 and uses these amplitude ratios to calculate data channel power imbalances at the transmitter. A gain control unit 240 then applies gain to the data signal at either a digital or analog stage, or both, to compensate for the detected power imbalance(s). It will be appreciated that the power of a signal, or a component of a signal (such as an amplitude-modulated pilot tone), is equal to the square of the amplitude of that signal or signal component. Therefore, any description of power herein may be understood to equivalently apply to amplitude as long as the mathematical relationship between amplitude and power is maintained. Thus, e.g., calculation of a power ratio between two signal components may be carried out as a calculation of a ratio of the square of the amplitude of each signal component.

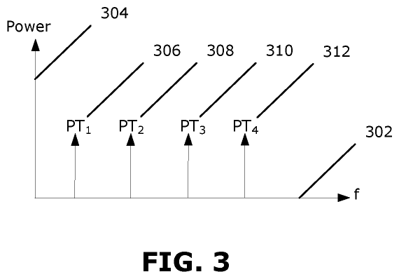

In operation, a digital data signal 204 is received by a transmitter digital signal processor (DSP) 214 (also called a digital signal processing unit). The transmitter DSP 214 generates four digital data channels 208 based on the digital data signal 204, each digital data channel 208 encoding a portion of the digital data signal 204. The transmitter digital signal processor 214 may also set or adjust the power level for the four digital data channels 208 encoding the digital data signal 204. The four digital data channels 208 are received by a pilot tone generator 216, which combines one or more pilot tones with the digital data signal 204 by modulating the amplitude of one or more of the four digital data channels 208 with a respective pilot tone 252, 254, 256, 258. Generation of the pilot tone(s) and combination of the pilot tone(s) with the four digital data channels 208 is described in greater detail below with reference to FIGS. 3-5. In FIG. 2, four pilot tones are shown corresponding to the four digital data channels 208. In this example, a first pilot tone PT1 252 is used to apply amplitude modulation equal to 1+m cos(2πf_{PT1}t) to a first digital data channel, wherein f_{PT1} indicates the frequency of the first pilot tone PT1 252 and m indicates the modulation index. Each of the other three digital data channels is similarly modulated by a respective pilot tone: second pilot tone PT2 254 (1+m cos(2πf_{PT2}t)), third pilot tone PT3 256 (1+m cos(2πf_{PT3}t)), and fourth pilot tone PT4 258 (1+m cos(2πf_{PT4}t)). Whereas the illustrated example of FIG. 2 shows the pilot tones as sinusoidal signals, it will be appreciated that other signal forms may be used for the pilot tones, such as square waves.

In some embodiments, the amplitude modulation may be applied by the pilot tone generator 216 at a frequency with an order of megahertz (MHz). In some embodiments, the amplitude modulation may be applied by the pilot tone generator 216 at a modulation index between 1% and 3%. Owing to the method of combining the pilot tone with the digital data signal, a high measurement sensitivity may be obtained in some embodiments using a small modulation index, e.g., less than 3%. A small modulation index may have a negligible impact on transmission performance. Embodiments using a lower modulation index (e.g., 1%) may require the use of a longer averaging window to detect the pilot tone than embodiments using a higher modulation index (e.g. 3%).

The pilot tone modulation performed by the pilot tone generator 216 generates a modified digital data signal represented by four modified digital data channels 210. The four modified digital data channels 210 are provided to a digital-to-analog converter (DAC) 218 to generate an analog data signal represented by four analog data channels 212. The four analog data channels 212 are provided to a set of four analog amplifiers 220, which generate an amplified analog data signal represented by four amplified analog data channels, namely analog electrical data channels 132, 134, 136, and 138. These channels are used to drive the EOM 100 as described above with reference to FIG. 1.

The pilot tone(s) are thus added to the digital data signal 204 by applying amplitude modulation. The optical signal 124 carrying the pilot tone(s) can be described by the equation

E_{PT}(t)=[1+m cos(2πf_{PT}t)]E(t) (1)

wherein f_{PT} is the pilot-tone frequency, m is the modulation index, E_{PT}(t) is the optical signal modulated with the pilot tone and E(t) is the optical signal without modulation by the pilot tone.

As described above, power imbalances introduced by the transmitter portion of the device 200 may be I/Q power imbalances or X/Y power imbalances. An IQ power imbalance can be described by

$${R}_{IQ} = \frac{{P}_{I , i}}{{P}_{Q , i}} ,$$

wherein i is X or Y. An XY power imbalance can be described by

$${R}_{XY} = \frac{{P}_{XI} + {P}_{XQ}}{{P}_{YI} + {P}_{YQ}} = \frac{{P}_{X}}{{P}_{Y}} .$$

A power-balanced signal will have R_{IQ} and R_{XY} both equal to one (i.e. 1:1, or 0 decibels in log scale).

It will be appreciated that the four digital data channels 208, modified by or combined with the four pilot tones 252, 254, 256, 258, correspond to the four modified digital data channels 210, which in turn correspond to digital version of the four analog data signals 212, which in turn, after being amplified by the amplifiers 220, correspond to the four orthogonal data channels 132, 134, 136, 138 used to drive the EOM 100. Thus, each set of four data channels 208, 210, or 212 may also be referred to herein as a set of four orthogonal data channels, and one or more of the operations described herein may in some embodiments be applied to the set of four orthogonal data channels at a different stage while still achieving the results described herein. Furthermore, as the data encoded in a given data signal or data channel may be equivalently encoded in the same signal or channel at a different stage (e.g., digital vs. analog, amplified vs. pre-amplified, optical vs. electrical), statements herein regarding the modulation of a signal or channel by another signal or channel, or the detection of characteristics of a first signal or channel in a second signal or channel, may refer to either direct or indirect modulation or detection. The four digital data signals 208 may be said to encode the digital data signal 204, whereas the analog data channels 212 or the amplified analog data channels 132, 134, 136, 138 may be said to encode the modified digital data channels 210, which in turn represent (or encode) the modified digital data signal.

The pilot tone detector 230 receives the optical signal 124 at a photo detector, shown here as a low-speed photodiode 232. The photodiode 232 generates a pilot tone detector analog signal 233 based on the optical signal 124, which is provided to an amplifier 234 to generate an amplified pilot tone detector analog signal 235. The amplified pilot tone detector analog signal 235 is provided to an analog-to-digital converter (ADC) 236, which generates a pilot tone detector digital signal 237.

The pilot tone detector digital signal 237 is provided to a pilot tone amplitude ratio detection unit 238, which calculates one or more power ratios between modulation components of the received signal to detect power imbalances between the modulation channels of the transmitter portion of the device 200. In some embodiments, the pilot tone detector digital signal 237 is represented by four channels corresponding to the four modulation channels 132, 134, 136, 138: a pilot tone detector XI channel, a pilot tone detector XQ channel, a pilot tone detector YI channel, and a pilot tone detector YQ channel. In some embodiments, these four channels may be identified in the pilot tone detector digital signal 237 and separated into separate channels by the pilot tone amplitude ratio detection unit 238. Pilot tone signal characteristics (such as amplitude) are determined based on the pilot tone detector digital signal 237, and the pilot tone signal characteristics are then used to determine at least one power imbalance between transmitter channels, according to the principles and techniques described below. In some embodiments, the detected power imbalance is a modulation component power imbalance between an I modulation component and a Q modulation component (such as XI and XQ, or YI and YQ) of the optical signal 124, indicating a power imbalance between I and Q channels of the transmitter. In some embodiments, the detected power imbalance is a polarization direction power imbalance between a first polarization direction and a second polarization direction of the optical signal of the optical signal 124, indicating a power imbalance between X and Y channels of the transmitter.

After being detected by the photodiode 232, the optical signal 124 induces a photo current proportional to the signal power of the optical signal 124:

$$I ( t ) = R {\vert {E}_{P T} ( t ) \vert}^{2} = R P ( t ) + {\underbrace{2 Rm cos ( 2 π {f}_{P T} t ) P ( t )}}_{PT} + R {O}^{2} ( m ) ( t ) \qquad ( 2 )$$

Wherein R is the responsivity of the photodiode, I(t) is the photo current, P(t) is the optical power of the optical signal 124, and O²(m) is the second-order small terms associated with m², which may be disregarded or omitted for some embodiments using a small modulation index. The pilot tone amplitude is thus proportional to the averaged optical power:

A_{PT}=Rm [symbol] P(t) [symbol] ≡RmP̅ (3)

Therefore, by modulating the pilot tone with the same modulation depth, to the I and Q data, the IQ power imbalance can be obtained from the amplitude ratio of the detected pilot tone in the I and Q data:

$${Γ}_{IQ} = \frac{{P}_{I}}{{P}_{Q}} = \frac{{A}_{PT , I}}{{A}_{PT , Q}} \qquad ( 4 )$$

An equivalent calculation yields the power imbalance between X and Y channels:

$${Γ}_{XY} = \frac{{P}_{X}}{{P}_{Y}} = \frac{{A}_{PT , XI} + {A}_{PT , XQ}}{{A}_{PT , YI} + {A}_{PT , YQ}} \qquad ( 5 )$$

Thus, the device 200 applies an amplitude modulated pilot-tone to the data channels, and the power ratios between the in-phase and quadrature data channels, and the signal power along X and Y polarizations, can be accurately measured by the pilot-tone detector 216 to determine IQ and/or XY power imbalances. As shown in equations (3) to (5), the power ratio between any I/Q data channel pair, calculated from the pilot-tone amplitude ratio, has no dependency on the modulator parameters (such as modulation slope and Vπ). Therefore, no calibration of the modulator parameters is needed. The pilot tone amplitude can be extracted from the power spectrum density obtained by performing a Fourier transform (e.g., a fast Fourier transform) of the pilot tone detector digital signal 237 with a digital signal processor (DSP) of the pilot tone amplitude ratio detection unit 238. In some embodiments, the pilot tone amplitude in each channel is monitored by the pilot tone detector 230 tapping a small portion of power to the pilot tone detector 230.

Once the pilot tone signal characteristics have been used to determine one or more power imbalances based on the power ratio F between the I and Q modulation components or X and Y polarization components of the optical signal 124, the pilot tone amplitude ratio detection unit 238 provides feedback based on the power imbalance(s) to a gain control unit 240. The gain control unit 240 may then be used to compensate for the detected power imbalance(s). In some embodiments, the gain control unit 240 compensates for an IQ power imbalance and/or XY power imbalance by applying digital gain to the four digital data channels 208 using the transmitter DSP unit 214, e.g. by adjusting the root-mean-square value of the modified digital data channels 210 received by the DAC 218. In some embodiments, the gain control unit 240 compensates for an IQ and/or XY power imbalance by applying analog gain adjustment to the four orthogonal channels XI 132, XQ 134, YI 136, and YQ 138 using the amplifiers 220, thereby changing the power level of the amplified analog data signal represented by amplified analog data channels 132, 134, 136, 138. Some embodiments may apply both digital gain and analog gain.

The decisions to apply gain, how much, and of what type (e.g., digital or analog) may be made by the pilot tone amplitude ratio detection unit 238 and/or the gain control unit 240 in various embodiments. In some embodiment, as separate power adjustment decision unit may be used to determine the power gain change value for each channels.

In some embodiments, the pilot tone detector 230 may be relatively low-cost. The pilot tone detector 230 may consist of a low-speed photodetector such as low-speed photodiode 232, an analog-to-digital convertor 236, and a pilot tone detector digital signal processor (DSP) (also called a pilot tone detector digital signal processing unit) implementing the pilot tone amplitude ratio detection unit 238.

In some embodiments, the above-described processes for power imbalance monitoring and compensation may be carried out in real time, i.e. during a service mode while the device 200 is being used to encode and transmit data over the optical communication link 202. In some embodiments, a calibration step is carried out during power-up or otherwise outside of the service mode. The calibration step may involve identifying any power imbalances and applying compensatory gain. For example, after several iterations of monitoring and compensation as described above, the gain control loop may lock the power of each channel (i.e. lock the gain applied to each channel) to a target value such that any channel power imbalances are compensated for. The optical signal power along X and Y directions may be automatically balanced as long as the data channel power imbalance is compensated. In some such embodiments, such a channel power/gain locking process could be performed during a power-up stage to achieve self-calibration for the transmitter. Some embodiments may carry out a calibration step at power-up, followed by real-time monitoring and compensation.

Because the pilot tone is generated and combined with the data signal at the digital stage, the pilot tone amplitude in the received optical signal is proportional to the data power of the underlying digital data signal. Thus, the calculated amplitude ratio between detected pilot tones in two modulation components is proportional the power ratio between the corresponding two data channels.

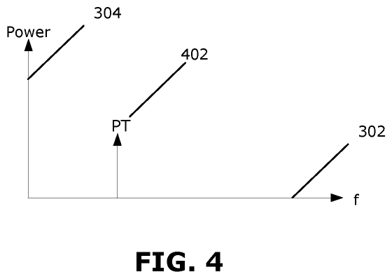

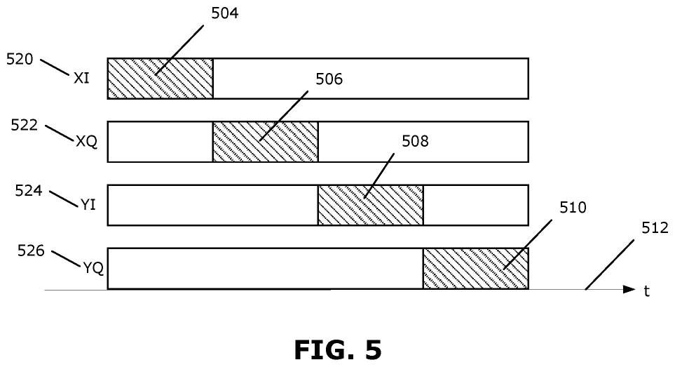

Different embodiments may use different pilot tone configurations, and may combine the pilot tone(s) with the digital data signal differently. A first example embodiment will be described with reference to FIG. 3, and a second example embodiments with reference to FIG. 4 and FIG. 5.

FIG. 3 is a graph of four pilot tone channels PT1 306, PT2 308, PT3 310, and PT4 312, on a power axis 304 and a frequency axis 302. In a first example embodiment, the four pilot tone channels 306, 308, 310, 312 are generated by the pilot tone generator 216 and combined with the respective digital data channels 208. The term “pilot tone channel” is intended to denote a pilot tone signal used to modulate the amplitude of a data channel of the transmitter. Each pilot tone channel has the same modulation index (shown as power level 304), and each pilot tone channel has a different frequency 302 from each other pilot tone channel. In this example embodiment, the power ratios among the four channels can be monitored at the same time by combining the four different pilot-tone channel frequencies with the four orthogonal digital signal channels, and using the pilot tone detector to detect the amplitude of each pilot tone channel simultaneously. Because the modulation index of the pilot tone is the same for each data channel, the power level 304 of the pilot tone present in each channel (i.e. each modulation component) of the optical signal 124 should be identical in a balanced signal, and any differences are indicative of a power imbalance. For this embodiment, the pilot tone detector 230 and/or a receiver receiving the optical signal 124 from the transmitter may need to be calibrated to compensate for the receiver frequency response ripple. This embodiment corresponds to the embodiment shown in FIG. 2 wherein each of the four pilot tones 252, 254, 256, 258 (i.e., each of the four pilot tone channels 306, 308, 310, 312) is modulated at a different modulation frequency, i.e. f_{PT1}, f_{PT2}, f_{PT3}, and f_{PT4}.

In a second example embodiment, receiver calibration may be avoided by using a time-alternating pilot tone detection scheme. FIG. 4 is a graph of a single pilot tone 402 on a power axis 304 (denoting the modulation index) and a frequency axis 302 in accordance with the second example embodiment. A single pilot tone 402 is applied at the same frequency 302 and same modulation index (corresponding to power 304) to the four data channels at alternating time periods. The pilot tone detection window of the pilot tone detector 230 is synchronized with the pilot tone generation timing of the pilot tone generator 216. The pilot tone amplitude ratio among the four data channels may be determined by looping the four channels.

FIG. 5 is a schematic showing injection of the single pilot tone 402 of FIG. 4 into four channels of a data signal at different predetermined times, in accordance with the second example embodiment. The four digital data channels 208 are shown here as an XI channel 520, an XQ channel 522, a YI channel 524, and a YQ channel 526, graphed along the time dimension 512. During a first predetermined time period 504, the single pilot tone 402 is combined with the XI channel 520. During a second predetermined time period 506, the single pilot tone 402 is combined with the XQ channel 522. During a third predetermined time period 508, the single pilot tone 402 is combined with the YI channel 524. And during a fourth predetermined time period 510, the single pilot tone 402 is combined with the YQ channel 526. This alternation of time periods may be looped at the pilot tone generator 216 and pilot tone detector 230 to implement continuous real-time monitoring, with each predetermined time period used by the pilot tone generator 216 to combine the pilot tone with the respective channel corresponding to a sampling time period used by the pilot tone detector 230 to sample the respective channel to detect the pilot tone amplitude therein.

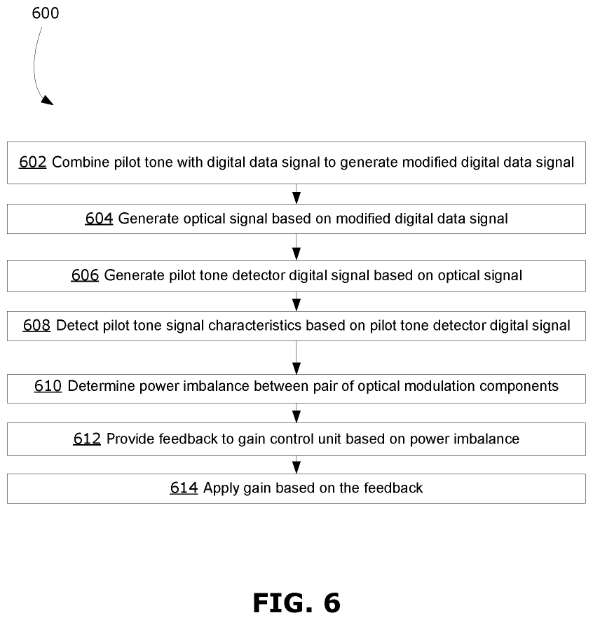

FIG. 6 is a flowchart showing an example method 600 of power imbalance compensation in a coherent transmitter in accordance with device 200 described above.

At 602, the pilot tone generator 216 is used to combine a pilot tone with a digital data signal 204, thereby generating a modified digital data signal, i.e. modified digital data channels 210.

At 604, the electro-optic modulator (EOM) 100 is used to generate an optical signal 124 based on the modified digital data signal. In device 200, this is accomplished by generating the analog data channels 212 based on the modified digital data channels 210 using the ADC 218, then using the amplifiers 220 to generate the amplified analog data channels 132, 134, 136, 138, which are in turn used to modulate the optical signal 124 via the EOM 100.

At 606, the pilot tone detector 230 is used to receive the optical signal and generate a pilot tone detector digital signal 237 based on the optical signal 124. In device 200, this is accomplished by receiving the optical signal 124 at the photodiode 232, thereby generating the pilot tone detector analog signal 233, which is amplified by the pilot tone amplifier 234 to generate the amplified pilot tone detector analog signal 235. The DAC 236 converts the amplified pilot tone detector analog signal 235 into the pilot tone detector digital signal 237.

At 608, pilot tone signal characteristics are detected based on the pilot tone detector digital signal 237. In device 200, this is accomplished by the pilot tone amplitude ratio detection unit 238. As described above, the pilot tone signal characteristics may be the amplitude of the pilot tone in each of two or more modulation components of the optical signal 124, as represented by the pilot tone detector digital signal 237. In some embodiments, such as the first example embodiment using four pilot tones as described with reference to FIG. 3 above, the pilot tone characteristics may be detected simultaneously in the four channels. In other embodiments, such as the second example embodiment using a single pilot tone alternating among the four channels as described with reference to FIG. 4 and FIG. 5 above, the pilot tone characteristics may be detected in the four channels at corresponding alternating or looping time periods.

At 610, at least one power imbalance between a pair of optical modulation components is detected using the pilot tone amplitude ratio detection unit 238 based on the pilot tone signal characteristics. As described above, this may consist of calculating the amplitude ratio between the pilot tone(s) in the two modulation components.

At 612, feedback is provided to gain control unit 240 based on the detected power imbalance(s). In device 200, the pilot tone amplitude ratio detection unit 238 provides feedback information to the gain control unit 240 indicating the amount of gain needed or the magnitude of each power imbalance to be compensated for.

At 614, the gain control unit 240 is used to apply gain based on the feedback. The gain control unit 240 applies digital gain to the data signal at a digital phase and/or analog gain to the data signal at an analog phase, as described above.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processor device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A device comprising:
a pilot tone generator configured to combine a pilot tone with a digital data signal, thereby generating a modified digital data signal;
a digital to analog converter (DAC) for generating an analog data signal based on the digital data signal;
an electro-optic modulator (EOM) configured to generate an optical signal based on the modified digital data signal, the optical signal including at least one in-phase modulation component and at least one quadrature modulation component;
a gain control unit; and
a pilot tone detector configured to:
receive the optical signal;
generate a pilot tone detector digital signal based on the optical signal;
detect pilot tone signal characteristics based on the pilot tone detector digital signal;
use the pilot tone signal characteristics to determine at least one modulation component power imbalance between at least one of the in-phase modulation components and at least one of the quadrature modulation components of the optical signal; and
provide feedback to the gain control unit based on the at least one modulation component power imbalance,
the gain control unit being configured to apply gain to the digital data signal or the analog data signal based on the feedback to compensate for the at least one modulation component power imbalance.

2. The device of claim 1, wherein:
the at least one in-phase modulation component comprises a first in-phase modulation component at a first polarization direction and a second in-phase modulation component at a second polarization direction;
the at least one quadrature modulation component comprises a first quadrature modulation component at a first polarization direction and a second quadrature modulation component at a second polarization direction;
the pilot tone detector is further configured to use the pilot tone signal characteristics to determine at least one polarization direction power imbalance between at least one of the modulation components at the first polarization direction and at least one of the modulation components at the second polarization direction; and
the feedback is also based on the polarization direction power imbalance.

3. The device of claim 2, wherein:
the modified digital data signal is encoded in four orthogonal data channels: an XI channel encoding the first in-phase modulation component, a XQ channel encoding the first quadrature modulation component, an YI channel encoding the second in-phase modulation component, and a YQ channel encoding the second quadrature modulation component; and
the electro-optic modulator comprises a dual-polarization quad-parallel Mach-Zehnder modulator having four channel paths, each channel path being modulated by one of the four orthogonal data channels.

4. The device of claim 3, wherein:
the pilot tone is combined with the digital data signal using amplitude modulation; and
detecting pilot tone signal characteristics based on the pilot tone detector digital signal comprises detecting an amplitude of the pilot tone in each of four channels of the pilot tone detector digital signal: a pilot tone detector XI channel, a pilot tone detector XQ channel, a pilot tone detector YI channel, and a pilot tone detector YQ channel.

5. The device of claim 4, wherein the pilot tone detector comprises:
a low-speed photodetector for receiving the optical signal and generating a pilot tone detector analog signal based on the optical signal;
an analog-to-digital converter (ADC) for generating the pilot tone detector digital signal based on the pilot tone detector analog signal; and
a pilot tone detector digital signal processing (DSP) unit for:
detecting the amplitude of the pilot tone in each of the four channels of the pilot tone detector digital signal by applying a fast Fourier transform to the pilot tone detector digital signal; and
using the pilot tone signal characteristics to determine the at least one modulation component power imbalance and the at least one polarization direction power imbalance by calculating one or more amplitude ratios between the pilot tone detected in two or more of the four channels of the pilot tone detector digital signal.

6. The device of claim 4, wherein:
the pilot tone comprises four pilot tone channels, each pilot tone channel having a different modulation frequency from the modulation frequency of each other pilot tone channel; and
each pilot tone channel is combined with one of the four orthogonal data channels to generate the modified digital data signal.

7. The device of claim 4, wherein:
combining the pilot tone with the digital data signal comprises:
for each of four predetermined time periods, combining the pilot tone with a respective channel of the four orthogonal data channels using amplitude modulation; and
detecting pilot tone signal characteristics comprises:
identifying the four channels of the pilot tone detector digital signal; and
for each of four sampling time periods, each sampling time period corresponding to one of the four predetermined time periods, detecting pilot tone signal characteristics of a respective channel of the pilot tone detector digital signal.

8. The device of claim 1,
further comprising:
an amplifier for amplifying the analog data signal to generate an amplified analog data signal, the amplified analog data signal driving the electro-optic modulator, the optical signal being based on the amplified analog data signal,
wherein:
the gain control unit applies gain adjustment based on the feedback to the amplifier to change a power level of the amplified analog data signal; and
generating an analog data signal based on the digital data signal comprises converting the modified electrical digital signal into the analog data signal.

9. The device of claim 8, further comprising a digital signal processing (DSP) unit for setting a power level of the digital data signal,
wherein the gain control unit further applies digital gain based on the feedback to the electrical digital signal using the DSP unit.

10. The device of claim 1, further comprising a digital signal processing (DSP) unit for setting a power level of the digital data signal,
wherein the gain control unit applies digital gain based on the feedback to the electrical digital signal using the DSP unit.

11. A method comprising:
using a pilot tone generator to combine a pilot tone with a digital data signal, thereby generating a modified digital data signal;
using a digital to analog converter (DAC) to generate an analog data signal based on the digital data signal;
using an electro-optic modulator (EOM) to generate an optical signal based on the modified digital data signal, the optical signal including at least one in-phase modulation component and at least one quadrature modulation component;
using a pilot tone detector to:
receive the optical signal;
generate a pilot tone detector digital signal based on the optical signal;
detect pilot tone signal characteristics based on the pilot tone detector digital signal;
use the pilot tone signal characteristics to determine at least one modulation component power imbalance between at least one of the in-phase modulation components and at least one of the quadrature modulation components of the optical signal; and
provide feedback to a gain control unit based on the at least one modulation component power imbalance;
using the gain control unit to apply gain to the digital data signal or the analog data signal based on the feedback to compensate for the at least one modulation component power imbalance.

12. The method of claim 11, wherein:
the at least one in-phase modulation component comprises a first in-phase modulation component at a first polarization direction and a second in-phase modulation component at a second polarization direction;
the at least one quadrature modulation component comprises a first quadrature modulation component at a first polarization direction and a second quadrature modulation component at a second polarization direction;
the pilot tone detector is further configured to use the pilot tone signal characteristics to determine at least one polarization direction power imbalance between at least one of the modulation components at the first polarization direction and at least one of the modulation components at the second polarization direction; and
the feedback is also based on the polarization direction power imbalance.

13. The method of claim 12, wherein:
the modified digital data signal is encoded in four orthogonal data channels: an XI channel encoding the first in-phase modulation component, a XQ channel encoding the first quadrature modulation component, an YI channel encoding the second in-phase modulation component, and a YQ channel encoding the second quadrature modulation component; and
the electro-optic modulator comprises a dual-polarization quadrature-phase Mach-Zehnder modulator having four channel paths, each channel path being modulated by one of the four orthogonal data channels.

14. The method of claim 13, wherein:
the pilot tone comprises four pilot tone channels, each pilot tone channel having a different modulation frequency from the modulation frequency of each other pilot tone channel; and
each pilot tone channel is combined with one of the four orthogonal data channels to generate the modified electrical digital signal.

15. The method of claim 13, wherein using the pilot tone signal characteristics to determine the at least one modulation component power imbalance and the at least one polarization direction power imbalance comprises:
detecting the amplitude of the pilot tone in each of the four channels of the pilot tone detector digital signal by applying a fast Fourier transform to the pilot tone detector digital signal; and
calculating one or more amplitude ratios between the pilot tone detected in two or more of the four channels of the pilot tone detector digital signal.

16. The method of claim 13, wherein:
combining the pilot tone with the digital data signal comprises:
for each of four predetermined time periods, combining the pilot tone with a respective channel of the four orthogonal data channels using amplitude modulation; and
detecting pilot tone signal characteristics comprises:
identifying four channels of the pilot tone detector digital signal; and
for each of four sampling time periods, each sampling time period corresponding to one of the four predetermined time periods, detecting pilot tone signal characteristics of a respective channel of the pilot tone detector digital signal.

17. A device comprising a pilot tone detector, the pilot tone detector comprising:
a low-speed photodetector for receiving an optical signal and generating a pilot tone detector analog signal based on the optical signal;
an analog-to-digital converter (ADC) for generating a pilot tone detector digital signal based on the pilot tone detector analog signal; and
a pilot tone detector digital signal processor (DSP) for:
detecting an amplitude of a pilot tone in each of four channels of the pilot tone detector digital signal by applying a fast Fourier transform to the pilot tone detector digital signal; and
using signal characteristics of the pilot tone to determine at least one power imbalance by calculating one or more amplitude ratios between the pilot tone detected in two or more of the four channels of the pilot tone detector digital signal.

18. The device of claim 17, wherein the at least one power imbalance includes a modulation component power imbalance between an in-phase modulation component and a quadrature modulation component of the optical signal.

19. The device of claim 17, wherein the at least one power imbalance includes a polarization direction power imbalance between a first polarization direction and a second polarization direction of the optical signal.

20. The device of claim 17, further comprising:
a pilot tone generator configured to combine the pilot tone with a digital data signal, thereby generating a modified digital data signal;
a digital-to-analog converter (DAC) for converting the modified electrical digital signal into an analog data signal;
an amplifier for amplifying the analog data signal to generate an amplified analog data signal for driving an electro-optic modulator;
an electro-optic modulator (EOM) configured to generate an optical signal based on the modified digital data signal; and
a gain control unit,
wherein:
the pilot tone detector DSP is further configured to provide feedback to the gain control unit based on the at least one power imbalance; and
the gain control unit is configured to:
apply digital gain based on the feedback to the digital data signal; and
apply analog gain based on the feedback to the amplified analog data signal.
